(19) United States
(12) Patent Application Publication
(10) Pub. No.: US 2025/0379259 A1
(43) Pub. Date: Dec. 11, 2025

(54) SOLID-STATE BATTERY ASSEMBLY

(71) Applicant: FORD GLOBAL TECHNOLOGIES, LLC, Dearborn, MI (US)

(72) Inventors: Hyukkeun OH, Ann Arbor, MI (US); Xin LIU, Novi, MI (US); Wendi ZHU, Northville, MI (US); Ali RASHTI, Canton, MI (US)

(21) Appl. No.: 18/737,548

(22) Filed: Jun. 7, 2024

(51) Int. Cl. H01M 10/0585; H01M 4/02; H01M 4/04; H01M 4/139; H01M 4/62; H01M 4/66; H01M 10/0525; H01M 10/0562; H01M 50/536; H01M 50/586; H01M 50/595

(52) U.S. Cl. CPC H01M 10/0585; H01M 4/0404; H01M 4/139; H01M 4/62; H01M 4/661; H01M 10/0525; H01M 10/0562; H01M 50/536; H01M 50/586; H01M 50/595; H01M 2004/027; H01M 2300/0068

(57) ABSTRACT

A solid-state battery has an anode including a metal foil current collector and an anode composite on the metal foil current collector such that the metal foil current collector defines an exposed area free of the anode composite. The solid-state battery also has a separator laminated on the anode composite and a tape attached on both sides of the anode, covering the exposed area.

### TECHNICAL FIELD

This disclosure relates to materials for lithium-ion batteries.

### BACKGROUND

Solid-state batteries include solid electrolyte material.

### SUMMARY

In one aspect of the disclosure, a method for preventing reaction of a metal foil current collector with a sulfide electrolyte material in a solid-state battery is presented. The method includes coating a metal foil current collector with an anode composite which contains a sulfide-based electrolyte material such that the metal foil current collector defines an exposed area free of the sulfide-based electrolyte material. The exposed area is covered with tape, and a separator is laminated onto the anode.

The metal foil current collector may be a copper foil current collector. In some embodiments, the tape is attached on both sides of the anode, covering the exposed area. The tape may include a transparent polyimide or a transparent polyethylene terephthalate, and a silicone adhesive or an acrylic adhesive. The tape may have a thickness ranging from 10 micrometers (μm) to 100 μm. The exposed area may have a width ranging from 1 millimeter (mm) to 10 mm. The separator may contain a sulfide-based electrolyte material, and the tape may be attached before laminating the separator on the anode composite. In some embodiments, the tape is attached before coating the anode composite onto the metal foil current collector, while in others, the tape is attached after coating the anode composite onto the metal foil current collector and before laminating the anode. The tape may be removed before notching the laminated anode into separate electrode sheets.

In another aspect of the disclosure, a solid-state battery is presented. The solid-state battery includes an anode with a metal foil current collector and an anode composite on the metal foil current collector such that the metal foil current collector defines an exposed area free of the anode composite, a separator laminated on the anode composite, and a tape attached on both sides of the anode, covering the exposed copper area.

The tape may be removed before welding a terminal tab onto the exposed metal area. The metal foil current collector may be a copper foil current collector. In some embodiments, the solid-state battery further includes a cathode including a cathode composite and a foil current collector. The separator may be positioned between the anode composite and the cathode composite. The tape may include a transparent polyimide or a transparent polyethylene terephthalate, and a silicone adhesive or an acrylic adhesive. The tape may have a thickness ranging from 10 μm to 100 μm. The exposed area of the metal foil current collector may have a width ranging from 1 mm to 10 mm. The anode composite and the separator may contain a sulfide-based electrolyte material.

In yet another aspect of the disclosure, a method for manufacturing a solid-state battery is presented. The method includes covering an exposed area of a copper foil current collector of an anode with tape, laminating a separator on an anode composite of the anode, and removing the tape. The tape may include a transparent polyimide or a transparent polyethylene terephthalate, and a silicone adhesive or an acrylic adhesive.

### BRIEF DESCRIPTION OF THE DRAWINGS

FIG. 1 is a schematic diagram of areas of interest in a reaction caused by sulfide materials contained in an anode composite and separator layer. Hydrogen sulfide gas produced by reaction between sulfide and moisture is a main reactant in the corrosion of copper;

FIG. 2 includes scanning electron microscope (SEM) with energy dispersive x-ray spectroscopy (EDS) images showing the presence of sulfide in the corroded copper foil;

FIG. 3 includes images of an exposed copper tab being corroded and/or mechanically impaired after heated compression or tab welding;

FIG. 4 is a schematic diagram of the taping process onto the exposed copper area after anode coating;

FIG. 5 is a schematic diagram of the pre-welding and tab welding process when the multiple bare copper tabs are welded together with the terminal lead tab;

FIG. 6 is a schematic diagram of a manufacturing process for solid-state batteries;

FIG. 7 shows methods of detecting usage of embodiments according to one or more aspects of the disclosure; and

FIG. 8 is a flowchart of method according to one or more aspects of the disclosure.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Unless otherwise explicitly specified, all numerical values and ranges relating to quantities, measurements, percentages, weights, and similar numerical references within this document are to be understood as being preceded by the term “about.” This applies even in cases where the term “about” is not explicitly used. It is intended that all values and ranges encompass variations that may arise from standard measurement, manufacturing processes, material properties, and intended functionality of aspects of the disclosure.

The development of solid-state batteries presents several challenges, particularly in terms of the compatibility between the electrode materials and the solid electrolyte. One of the commonly investigated solid electrolyte materials is sulfide-based electrolyte, which has been shown to exhibit high ionic conductivity and low interfacial resistance with electrode materials. Despite these advantages, sulfide-based electrolytes have been found to react with certain components of the battery, such as the foil current collector, under certain conditions.

Various approaches have been proposed to address the challenges associated with the integration of sulfide-based electrolytes in solid-state batteries. These approaches include the use of coatings, alternative current collector materials, and modifications to the manufacturing process.

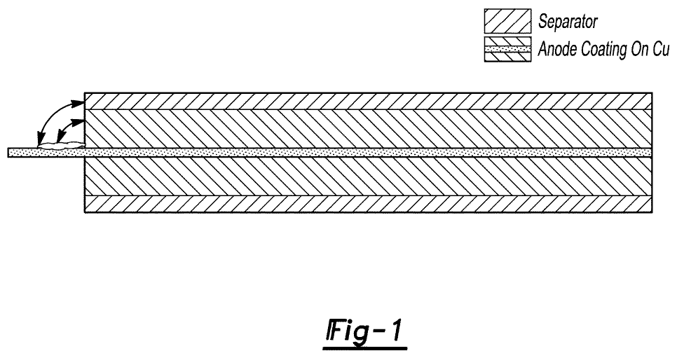

FIG. 1 is a schematic diagram showing the areas of interest for reaction caused by the sulfide materials contained in the anode composite and separator layer. In a typical solid-state battery design, a thin copper foil as the anode current collector is coated by an anode composite which contains a sulfide-based electrolyte material to facilitate ion conduction through the anode layer. A separator with a sulfide-based electrolyte material as the main component is also laminated upon the anode, in which the separator is closely adjacent to the copper foil near the anode edge. The copper foil readily reacts with the sulfide material, forming reaction layers on the surface showing discoloration and embrittlement. This reaction occurs even at room temperature and worsens at elevated temperatures, especially with even a trace amount of moisture present, which forms highly reactive hydrogen sulfide gas with the sulfide material.

FIG. 2 shows a SEM-EDS analysis illustrating the presence of sulfur in the corroded copper foil. EDS of the discolored copper foil shows that sulfur was present in the traditional copper foil in round spots. This confirmed that copper reacted with sulfides.

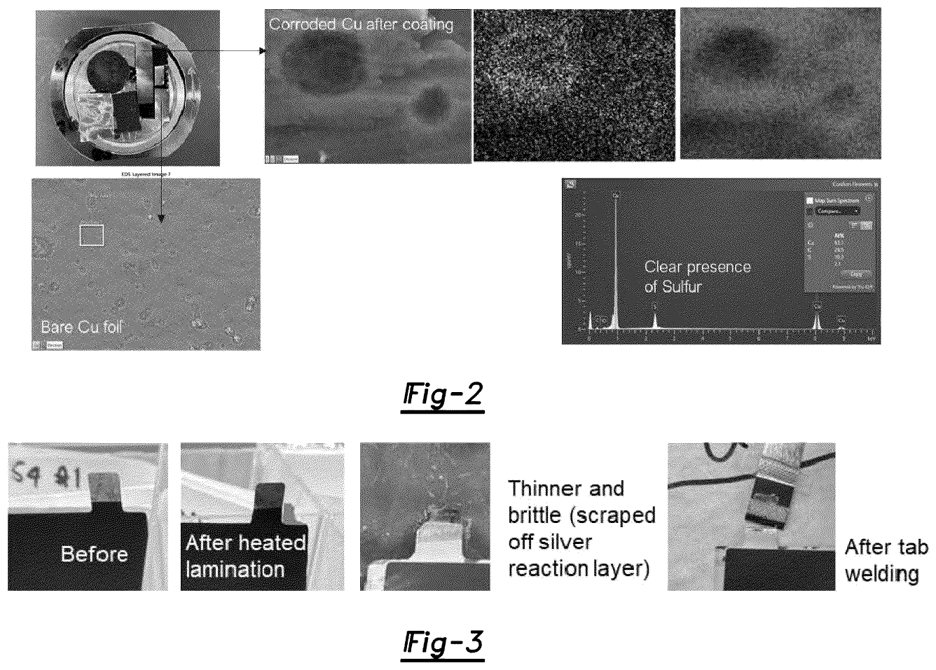

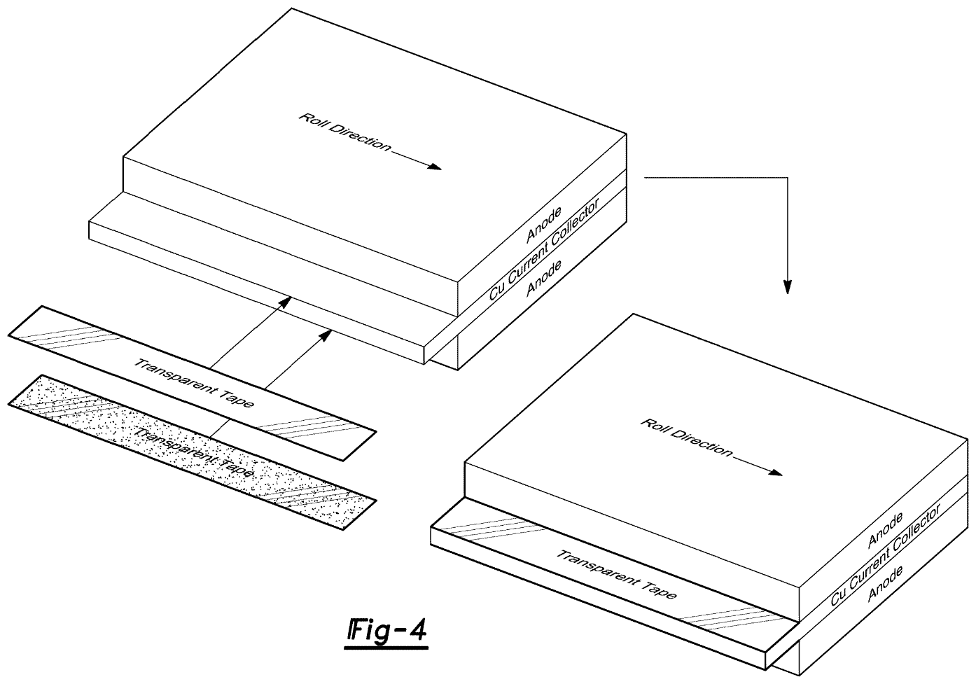

FIG. 3 shows images of the exposed copper tab being corroded and/or mechanically impaired after heated compression or tab welding. The embrittlement that occurs when copper reacts with sulfide makes the thin copper foil susceptible to mechanical impairment. Tearing of the copper tab might occur during the heated compression and tab welding steps, especially after reaction with sulfide, which may lead to low production yield.

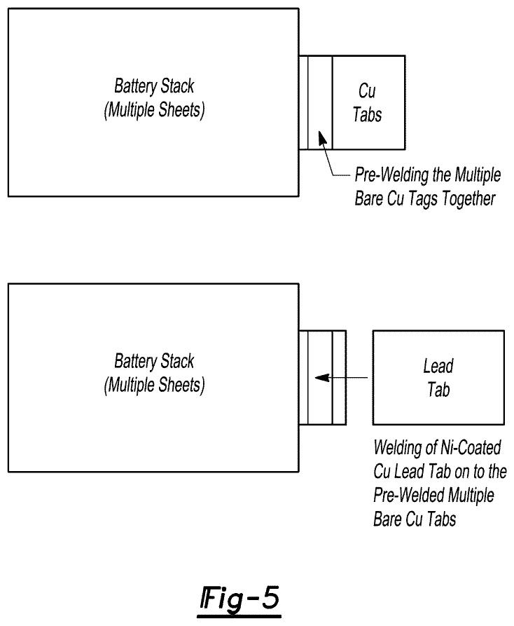

FIG. 4 is a schematic showing the taping process onto the exposed copper area after anode coating. A solution to prevent mechanical impairment on the anode copper tab during heated compression and welding is proposed, which includes attaching a transparent tape on both sides of the double-coated anode, covering the exposed copper tab area, and thus preventing the reaction between copper and sulfide.

FIG. 5 is a schematic diagram showing the pre-welding and tab welding process when the multiple bare copper tabs are welded together and then with the terminal tab. The tape should be removed before the welding step to allow for welding the terminal tab onto the exposed copper tab.

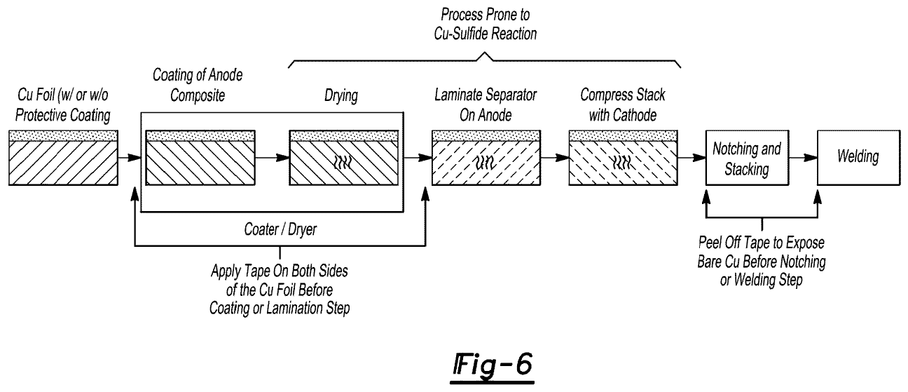

FIG. 6 is a schematic diagram of a manufacturing process for solid-state batteries. The process may be prone to a copper-sulfide reaction when a laminate separator is on an anode prior to compression of a stack with a cathode. Applying a tape during this manufacturing process may mitigate some of these effects. The exact schedule when to attach the tape can vary, depending on several process conditions such as whether attaching the tape on the copper foil before coating the slurry is appropriate, the coating process parameters and coating quality, and how the drying process is designed after coating the anode slurry composite onto the copper foil.

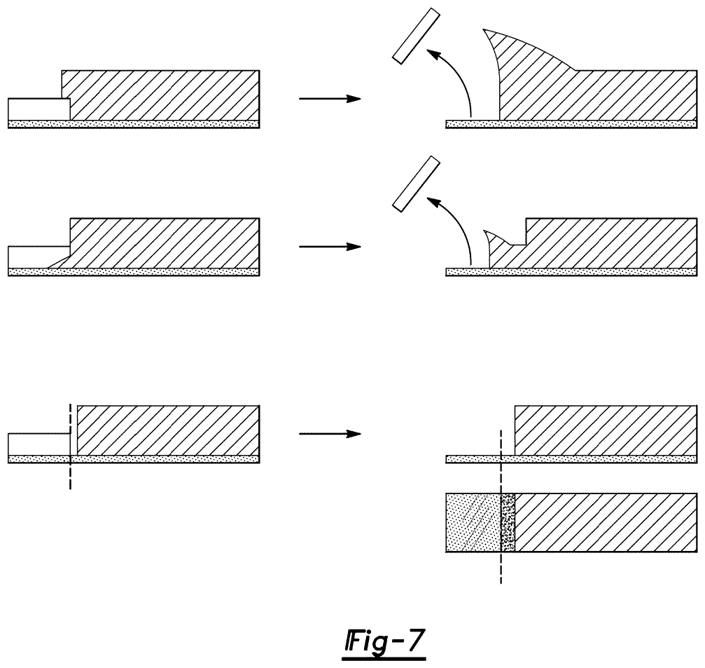

FIG. 7 shows methods of detecting tape use after cell teardown. After teardown of the cell, optical microscopy or surface analysis of the area near the coating edge of the anode may reveal whether taping occurred before and/or after slurry coating, because application and detachment of the tape should leave marks near the coating edge.

The solid-state battery of the present disclosure has an anode including a metal foil current collector and an anode composite on the metal foil current collector such that the metal foil current collector defines an exposed area free of the anode composite, a separator laminated onto the anode composite, and a tape attached on both sides of the anode, covering the exposed area. The tape is configured to be removed before welding a terminal tab onto the exposed area.

In some embodiments, the solid-state battery further includes a cathode including a cathode composite and a foil current collector. The separator is positioned between the anode composite and the cathode composite.

The tape used in the solid-state battery can be a transparent polyimide or transparent polyethylene terephthalate, with a silicone adhesive or an acrylic adhesive. The tape may have a thickness ranging from 10 μm to 100 μm, and the exposed area of the metal foil current collector may have a width ranging from 1 mm to 10 mm. Additionally, the anode composite and the separator may contain a sulfide-based electrolyte material.

The present disclosure also relates to a method for manufacturing a solid-state battery, which includes providing an anode with a copper foil current collector and an anode composite, covering the exposed area of the copper foil current collector with tape, laminating a separator on the anode composite, and removing the tape before welding a terminal tab onto the exposed area.

In some embodiments, the method further includes laminating a cathode on the separator, wherein the cathode includes a cathode composite and a foil current collector.

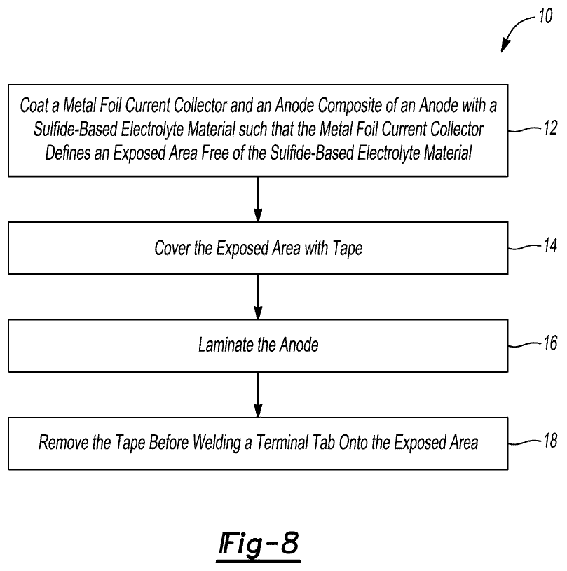

FIG. 8 shows a flowchart of a method 10 for preventing reaction of a metal foil current collector with a sulfide electrolyte material in a solid-state battery. The method begins at step 12 by coating a metal foil current collector with an anode composite which contains a sulfide-based electrolyte material such that the metal foil current collector defines an exposed area free of the sulfide-based electrolyte material. At step 14, the exposed area is covered with tape. The separator is then laminated onto the anode at step 16. Finally, at step 18, the tape is removed before welding a terminal tab onto the exposed area.

This method provides a solution to prevent mechanical impairment on the anode metal tab during heated compression and welding by attaching a tape on both sides of the anode, covering the exposed tab area, and thus preventing the reaction between metal and sulfide. The tape is removed before the welding step to allow for welding the terminal tab onto the exposed metal tab. This effective approach can be easily integrated into the solid-state battery manufacturing process, helping to increase production yield and battery performance.

The transparency of the tape allows for visual inspection of the metal foil surface to monitor for any potential discoloration or reaction with the sulfide-based electrolyte material. The tape may have a thickness ranging from 10 μm to 100 μm, and the exposed area of the metal foil current collector may have a width ranging from 1 mm to 10 mm, depending on the specific design and requirements of the solid-state battery.

The methods described may be applied to various solid-state battery configurations, including those with a cathode comprising a cathode composite and a foil current collector.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. Metals other than copper, for example, can be used. The words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A method for preventing reaction between a metal foil current collector and a sulfide electrolyte material in a solid-state battery comprising:
coating a metal foil current collector with an anode composite that contains a sulfide-based electrolyte material such that the metal foil current collector defines an exposed area free of the sulfide-based electrolyte material;
covering the exposed area with tape;
laminating a separator onto the anode to form a laminated anode; and
removing the tape before welding a terminal tab onto the exposed area.

2. The method of claim 1 wherein the tape is attached on both sides of the anode, covering the exposed area.

3. The method of claim 1 wherein the tape includes a transparent polyimide or a transparent polyethylene terephthalate, and a silicone adhesive or an acrylic adhesive.

4. The method of claim 1 wherein the tape has a thickness ranging from 10 μm to 100 μm.

5. The method of claim 1 wherein the exposed area has a width ranging from 1 mm to 10 mm.

6. The method of claim 1 wherein the separator further contains additional sulfide-based electrolyte material onto the anode composite.

7. The method of claim 1 wherein the metal foil current collector is a copper foil current collector.

8. The method of claim 1 wherein covering the exposed area with tape occurs before coating the metal foil current collector with the anode composite.

9. The method of claim 1 wherein covering the exposed area with tape occurs after coating the metal foil current collector with the anode composite.

10. The method of claim 1 further comprising notching the laminated anode, wherein the removing occurs before the notching.

11. A solid-state battery comprising:
an anode including a metal foil current collector and an anode composite on the metal foil current collector such that the metal foil current collector defines an exposed area free of the anode composite;
a separator laminated on the anode composite; and
a tape attached on both sides of the anode, covering the exposed area, and configured to be removed before a terminal tab is welded onto the exposed area.

12. The solid-state battery of claim 11 wherein the metal foil current collector is a copper foil current collector.

13. The solid-state battery of claim 11 further comprising a cathode composite, a foil current collector, and a separator positioned between the anode composite and the cathode composite.

14. The solid-state battery of claim 11 wherein the tape includes transparent polyimide or a transparent polyethylene terephthalate, and a silicone adhesive or an acrylic adhesive.

15. The solid-state battery of claim 11 wherein the tape has a thickness ranging from 10 μm to 100 μm.

16. The solid-state battery of claim 11 wherein the exposed area has a width ranging from 1 mm to 10 mm.

17. The solid-state battery of claim 11 wherein the anode composite and the separator contain a sulfide-based electrolyte material.

18. A method for manufacturing a solid-state battery comprising:
covering an exposed area of a copper foil current collector of an anode with tape;
laminating a separator onto an anode composite of the anode; and
removing the tape.

19. The method of claim 18 wherein the tape includes a transparent polyimide or a transparent polyethylene terephthalate, and a silicone adhesive or an acrylic adhesive.
